(19) United States
(12) Patent Application Publication
(10) Pub. No.: US 2010/0154475 A1
(43) Pub. Date: Jun. 24, 2010

(54) PROCESS FOR THE PRODUCTION OF HIGH PURITY ELEMENTAL SILICON

(76) Inventors: Andrew Matheson, Belmont, MA (US); John W. Koenitzer, Carlisle, MA (US)

Correspondence Address: BANNER & WITCOFF, LTD., 28 STATE STREET, SUITE 1800, BOSTON, MA, 02109-1701, US

(21) Appl. No.: 12/695,360

(22) Filed: Jan. 28, 2010

Related U.S. Application Data
(63) Continuation of application No. PCT/US2008/071729, filed on Jul. 31, 2008.
(60) Provisional application No. 60/953,450, filed on Aug. 1, 2007.

(51) Int. Cl. C01B 33/021; C03B 19/02; C03B 32/00

(52) U.S. Cl. 65/33.2; 423/350

(57) ABSTRACT

This invention relates to a process for the production of high purity elemental silicon by reacting silicon tetrachloride with a liquid metal reducing agent in a two reactor vessel configuration. The first reactor vessel is used for reducing the silicon tetrachloride to elemental silicon, resulting in a mixture of elemental silicon and reducing metal chloride salt while the second reactor vessel is used for separating the elemental silicon from the reducing metal chloride salt. The elemental silicon produced using this invention is of sufficient purity for the production of silicon photovoltaic devices or other semiconductor devices.

### CROSS-REFERENCE TO RELATED APPLICATIONS

This application is a continuation of PCT Application No. PCT/US2008/071729 filed 31 Jul. 2008, which was published in the English language as PCT Publication No. WO 2009/018425 on 5 Feb. 2009. The PCT Application claims priority from U.S. Provisional Application Ser. No. 60/953,450, filed Aug. 1, 2007, the disclosure of which is hereby incorporated herein by reference.

### FIELD OF THE INVENTION

This invention relates to a process for the production of high purity elemental silicon by reacting silicon tetrachloride with a liquid metal reducing agent in a two reactor vessel configuration.

### BACKGROUND OF THE INVENTION

Silicon tetrachloride (SiCl₄) is commercially available; for example, Sigma-Aldrich sells 99% SiCl₄ in a 200 liter quantity for $4890.00. See the 2007-2008 Catalog—Item No. 215120-200L. Other quantities and purities are also available from this, and other commercial sources.

However, given the high cost of purified SiCl₄, the process of the present invention includes the optional step of generating SiCl₄ from one or more silica-bearing materials, such as for example siliceous shale (see U.S. Pat. No. 1,858,100) and silica flour, silica flume, pulverized silica sand, and rice hulls (see U.S. Pat. No. 4,237,103). Other silica-bearing materials are also known and readily available.

### SUMMARY OF THE INVENTION

This invention relates to a process for the production of high purity elemental silicon by reacting silicon tetrachloride (or an equivalent tetrahalide) with a liquid metal reducing agent in a two stage reaction. The first stage involves reducing silicon tetrachloride to elemental silicon, resulting in a mixture of elemental silicon and one or more reducing metal chloride salts. The second stage involves separating the elemental silicon from the reducing metal chloride salts. In certain embodiments, two reaction vessels are employed for these processing steps.

In preferred embodiments, the elemental silicon produced by the process of this invention is of sufficient purity for the production of silicon photovoltaic devices or other semiconductor devices.

One preferred process of the present invention comprises the steps of:
(a) introducing silicon tetrachloride and an alkali or alkaline earth metal reducing agent into a reactor at temperatures below the boiling point temperature of the alkali or alkaline earth metal, thereby producing an alkali or alkaline earth chloride salt and elemental silicon mixture, and
(b) separating the alkali or alkaline earth chloride salt from the elemental silicon.

Optionally, a preliminary step before step (a) entails chlorinating a silica-bearing material to produce silicon tetrachloride. An especially preferred silica-bearing material is sand, SiO₂ for silica. As a silicon source for reduction, SiCl₄ is the preferred material.

In certain preferred embodiments of the present invention, the silicon tetrachloride and alkali or alkaline earth metal reducing agent, are introduced into the reaction vessel as liquids.

In certain preferred embodiments of the present invention, the alkali or alkaline earth chloride salt and elemental silicon mixture are separated by heating the mixture in a second reaction vessel above the boiling point of the alkali or alkaline earth chloride salt.

In certain preferred embodiments of the present invention, the alkali or alkaline earth chloride salt and elemental silicon mixture is separated using water to dissolve the alkali or alkaline earth chloride salt in a second reaction vessel.

In certain preferred embodiments of the present invention, the alkali or alkaline earth chloride salt and elemental silicon mixture are separated by heating the second reaction vessel to temperatures between 600° C. and the boiling temperature of the alkali or alkaline earth chloride salt with application of a vacuum of less than 100 microns, to remove the alkali or alkaline earth salt.

In certain preferred embodiments of the present invention, the alkali or alkaline earth metal reducing agent is sodium, potassium, magnesium, calcium, or a combination of two or more of these metals.

In certain preferred embodiments of the present invention, the alkali or alkaline earth metal reducing agent is sodium metal.

In certain preferred embodiments of the present invention, the elemental silicon produced by the process has a purity of at least 99.9%.

In certain preferred embodiments of the present invention, the elemental silicon produced by the process has a purity of at least 99.99%.

In certain preferred embodiments of the present invention, the elemental silicon produced by the process has a purity of at least 99.999%.

In certain preferred embodiments of the present invention, the elemental silicon produced by the process has a purity of at least 99.9999%.

### DETAILED DESCRIPTION OF THE PREFERRED EMBODIMENTS

As described above, one preferred embodiment of the present invention is a process for the production of high purity elemental silicon by reacting silicon tetrachloride with a liquid metal reducing agent in a two stage process. The first stage is used for reducing the silicon tetrachloride to elemental silicon, resulting in a mixture of elemental silicon and a chloride salt of the reducing metal while the second reactor vessel is used for separating the elemental silicon from the reducing metal chloride salt. The elemental silicon produced using this invention is of sufficient purity for the production of silicon photovoltaic devices or other semiconductor devices.

The liquid metal reducing agent can be any of the alkali and alkaline earth metals, preferably, sodium, potassium, magnesium, calcium, or any mixture of two or more of these metals.

In certain embodiments, using sodium as the liquid metal reducing agent, the reaction streams can be introduced into reactor vessel 1 in either of two modes:

The first mode is to introduce the reactants into reactor vessel 1 as vapor—liquid feed streams, e.g., silicon tetrachloride vapor is fed into the reactor vessel 1 and is reduced using liquid sodium metal at temperatures above 100° C.

The second reactant introduction mode, the preferred reactant introduction mode, is to introduce the reactants into reactor vessel 1 as liquid—liquid feed streams, e.g., liquid silicon tetrachloride is fed into reactor vessel 1 at temperatures between 0° and 70° C. and pressures between 1 and 10 atm and is reduced by liquid sodium at temperatures above 100° C.

In both reactant introduction modes, the resultant product includes a mixture of elemental silicon and sodium chloride. If the metal reducing agent includes other metals or combinations of metals, elemental silicon and chloride salts of the other metals will be formed.

Reactor vessel 1 can be made of stainless steel or any other corrosion resistant high temperature metal or alloy. Reactor vessel 2, used for removal of the salt through sublimation, is preferably coated on the interior with a high purity alumina ceramic or semiconductor grade quartz glass.

If water is used to remove the salt, the reaction can be accomplished totally in reactor vessel 1. Thus, while the majority of the process (99% purity) can be achieved in a single reactor vessel, a final purifying melt step, i.e., melt purification of the silicon into a boule or ingot, is preferably carried out in a second reactor vessel, whereby higher purity silicon is achieved. A high temperature vacuum melting of the silicon is preferably employed as the final purification step. Reactor vessel one could be operated to remove excess sodium and also sodium chloride by the techniques described for reactor vessel 2.

Reactor vessel 1 can be operated as either a continuous or batch reactor vessel. Operating reactor vessel 1 as a continuous reactor, liquid sodium metal is mixed with either vapor or liquid silicon tetrachloride at temperatures between 0° and 70° C. and pressures between 1 and 10 atm using a mixing nozzle, resulting in the continuous production of elemental silicon from the reduction of silicon tetrachloride. In batch operation, reactor vessel 1 is filled with liquid sodium at temperatures above 100° C. Silicon tetrachloride is then injected into the liquid sodium as a vapor at temperatures above 100° C. or as a liquid at temperatures between 0° and 70° C. and pressures between 1 and 10 atm. In both continuous and batch operation, reactor vessel 1 is run with at least 1 to 10% excess sodium metal, resulting in silicon metal with low metal impurities. Operating reactor vessel 1 in a continuous manner, the feed streams are introduced into the reactor vessel with between 1 and 10% excess sodium metal over the stoichiometric reaction requirements. With batch operation, the injection of silicon tetrachloride is stopped before consuming all the sodium initially loaded into reaction vessel 2, thereby preserving a sodium excess environment.

The second reactor vessel is used for purification of the silicon—i.e., to separate the sodium chloride from the elemental silicon—sodium chloride mixture. This is accomplished by operating reactor vessel 2 in one of the following preferred modes:
(1) Heating reactor vessel 2 to temperatures greater than 1470° C. At these temperatures, the sodium chloride is above its boiling point and the elemental silicon is a liquid. The temperature of reactor vessel 2 is maintained above 1470° C. until all sodium chloride is removed from the liquid silicon metal. Once all the sodium chloride is removed from the molten silicon, reactor vessel 2 is cooled to room temperature, resulting in a high purity silicon boule that can be further processed for producing silicon for photovoltaic devices.
(2) Operating reactor vessel 2 is as a water-washing vessel. The sodium chloride is dissolved from the silicon—sodium chloride mixture by adding deionized (DI) water to reactor vessel 2 at temperatures between 50°-95° C. The DI water silicon-sodium chloride mixture is stirred for 10-60 minutes then the salt containing water is removed from reactor vessel 2. This process is repeated until all the sodium chloride is removed.
(3) Heating reactor vessel 2 to temperatures between 600° C. and the boiling temperature of the alkali or alkaline earth salt and applying a vacuum of at least 100 microns. The sodium chloride sublimes from the silicon-sodium chloride mixture, resulting in a silicon powder that can be further processed for producing silicon for photovoltaic devices.

All operating conditions described above for reactor vessels 1 and 2 yield elemental silicon metal of at least 99.9% purity with less than 10 ppm boron and phosphorous. Boron and phosphorous are the two impurities that are not removed by crystallizing the Si. Also, B and P greatly influence the electrical properties of the Si. Therefore, most specifications for PV grade Si have more restricted B and P levels than other contaminants. Preferably, the combined level of boron and phosphorous in the silicon of the present invention is less than 1 ppm, more preferably less than 0.1 ppm, most preferably less than 0.01 ppm, and less than 0.001 ppm.

Through careful control of operating conditions, it is possible to produce silicon metal with purity preferably greater than 99.99%, more preferably greater than 99.999%, and most preferably greater than 99.9999%; each with boron and phosphorous levels of less than 0.1 ppm. The operating conditions, specifically the atmosphere over the reactants need to be controlled to prevent air or moisture from interacting with the reactants. Also, the exotherm of the reaction needs to be controlled to prevent high temperature excursions. Finally, proper cleaning, storage, handling, and loading of the reactors are required to prevent corrosion of the reactor. The exact conditions will depend on the reaction scale, that is, size of the reactor and reaction rates.

The high purity silicon produced by the process of the present invention may be further processed for producing silicon used for photovoltaic devices. For example, purified silicon produced by this process may be further melted to form an ingot for photovoltaic usage, and this step will cause some additional purification of the silicon metal. For example, boules or ingots may be cut into wafers and polished. Thereafter, semiconductor junctions may be formed by diffusing dopants.

It should be understood that the foregoing description is only illustrative of the present invention. Various alternatives and modifications can be devised by those skilled in the art without departing from the invention. Accordingly, the present invention is intended to embrace all such alternatives, modifications and variances that fall within the scope of the appended claims.

What is claimed is:

1. A process for producing elemental silicon having a purity of at least 99.9% silicon, comprising the steps of:
(a) introducing liquid silicon tetrachloride and an alkali or alkaline earth metal reducing agent in liquid form into a first reaction vessel at temperatures below the boiling point temperature of the alkali or alkaline earth metal, producing an alkali or alkaline earth chloride salt and elemental silicon mixture, and
(b) separating the alkali or alkaline earth chloride salt from the elemental silicon in a second reaction vessel.

2. The process of claim 1, further comprising a preliminary step conducted before step (a) which comprises chlorinating a silica-bearing material to produce liquid silicon tetrachloride.

3. The process of claim 1 or 2, where the alkali or alkaline earth chloride salt and elemental silicon mixture are separated by heating the second reaction vessel above the boiling point of the alkali or alkaline earth chloride salt.

4. The process of claim 3, where the alkali or alkaline earth chloride salt and elemental silicon mixture are separated using water to dissolve the alkali or alkaline earth chloride salt in the second reaction vessel.

5. The process of claim 3, where the alkali or alkaline earth chloride salt and elemental silicon mixture are separated by heating the second reaction vessel to temperatures between 600° C. and the boiling temperature of the alkali or alkaline earth chloride salt and applying vacuum of less than 100 microns to remove the alkali or alkaline earth salt.

6. The process of claim 3, where the alkali or alkaline earth metal reducing agent is sodium, potassium, magnesium, calcium, or a combination of two or more of these metals.

7. The process of claim 3, where the alkali or alkaline earth metal reducing agent is sodium metal.

8. The process of claim 1 or 2, where the purification of the elemental silicon is fully accomplished in the first reaction vessel.

9. The process of claim 1 or 2, where the purification of the elemental silicon is partially accomplished in the first reaction vessel, with final purification occurring in the second vessel.

10. A process according to claim 1 or 2, where the purity of the product elemental silicon is at least 99.99%.

11. A process according to claim 1 or 2, where the purity of the product elemental silicon is at least 99.999%.

12. A process according to claim 1 or 2, where the purity of the product elemental silicon is at least 99.9999%.

13. An elemental silicon material produced by the process described in claim 1 or 2, having a silicon purity in the range of from at least 99.99% to at least 99.9999%.

14. The elemental silicon material of claim 13, wherein the material comprises silicon and a combined level of boron and phosphorous in the range of from less than 10 ppm to less than 0.0001 ppm.

15. An ingot of silicon, produced from the material of claim 14, produced by a method of casting the elemental silicon material.

16. The ingot of silicon of claim 15, wherein the casting method is selected from vacuum arc remelting or electron beam melting.

17. A process according to claim 1 or 2, further comprising step (c) which follows step (b) and comprises producing an ingot of the elemental silicon by a method of casting.

18. The process of claim 17, wherein the casting method is selected from vacuum arc remelting or electron beam melting.
